(19) United States
(12) Patent Application Publication
(10) Pub. No.: US 2019/0124951 A1
(43) Pub. Date: May 2, 2019

(54) ENHANCED FLOWABLE DRIED DISTILLLER GRAINS

(71) Applicant: SUSAN KAYE SEATON, LAKEVILLE, MN (US)

(72) Inventor: SUSAN KAYE SEATON, LAKEVILLE, MN (US)

(21) Appl. No.: 15/401,301

(22) Filed: Jan. 9, 2017

(51) Int. Cl. A23K 20/28; A23K 10/38; A23K 20/24; A23K 30/20

(52) U.S. Cl. CPC A23K 20/28; A23K 30/20; A23K 20/24; A23K 10/38

(57) ABSTRACT

The present invention provides a process for producing an enhanced dried distiller grains comprising a blend of mineral blended anticaking additive introduced after the cooling step in the manufacture of dried distiller grains. Preferably the mineral blended dried distiller grains has enhanced flowability without agglomeration.

### BACKGROUND

Distiller grains are used as a versatile feedstuff for the concentrated feed package in most classes of animal feed diets. Distiller grains may be produced as wet modified or dried distiller grains (DDGs). Without regard to the process of production, the distiller grains in use as a concentrated feed package needs to be free flowing or at least be usable for its intended purpose without causing an end-use loss of time and energy in ensuring that the product does not cake or stick to the equipment used. It is reasonable to imagine the loss of revenue in time and labor when the feed product ends up clumping and sticking to the equipment or for the purpose—not flowing well.

Agglomeration is a common occurrence in the production of distiller grains. Since these products are produced wet, modified or dried; the process of agglomeration may in essence cause even the dried distiller grains to clump up and stick to the delivery equipment. The sticking or clumping is a deterrent to efficient processing and causes loss of time and labor. Other issues that crop up in the course of producing useful amounts of distiller grains include concerns for the loading operation that may make it unsafe for front-end loader operators, as can be imagined with the caking of the DDGs which may cause bridging in the storage barns.

Another issue of concern in the production and storage of DDGs is the energy typically expended in drying the distiller grains. As with any product that may need to be dried prior to storage or loading onto a truck, the amount of energy needed to obtain the appropriate dryness depends on the amount of moisture and the intended dryness of the milled grains. This concern for energy usage and the attendant implications thereof express the enormous value in efforts to reduce the amount of energy expended for each intended drying purpose.

From the foregoing, it will be appreciated that what is needed in the art is a better flowing, easier to dry and lower moisture level in the distiller grains for ease of load and unloading in the feed industry. Such a process to produce dried distiller grain and similar DDGs is disclosed and claimed herein.

### SUMMARY

In one embodiment, the present invention provides a process for blending an anticaking or mineral blend additive for the intended flowability desired of dried distiller grains.

In another embodiment of the present invention a preservative or mold inhibitor is provided that preferably absorbs moisture and mitigates the establishment of mold spores in the dried distiller grains.

Another benefit of the mineral blend additive provided according to the present invention is the preferred enhancement of the color properties of the dried distiller grains for a more pleasant looking product.

In yet another embodiment of the present invention is the provision of a mineral blend additive wherein when added to distiller grains as appropriate, enhanced the flowability of the dried distiller grains for more efficient loading and unloading onto trucks and rail cars.

In another embodiment of the present invention, the additive blend is suitable to provide a lowering of the moisture level in the dried distiller grain, enhancing the value to the product.

A benefit of the mineral blend additive according to an embodiment of the present invention is a source of an anti-oxidant wherein when ingested, provides a high negative ionic charge, attracting toxins and parasites for eventual removal through the digestive tracts of the fed animal.

Another direct benefit of the product of the present invention is the reduction in energy use, an energy savings that is attributable to the reduced need for energy in drying the distiller grains.

### BRIEF DESCRIPTION OF THE FIGURES

FIG. 1 provides a perspective view of a bin that may be usable in accordance with the present invention,

FIG. 2A provides a perspective view of a blender and conveyor usable according to the present invention

FIG. 2B provides a perspective view of a bin and conveyor usable according to the present invention

### DETAILED DESCRIPTION

The present invention provides a process for blending an anticaking or mineral blend additive for the intended flowability desired for dried distiller grains. In another embodiment of the present invention a preservative is provided that preferably absorbs moisture and mitigates the establishment of mold spores in the dried distiller grains. Another benefit of the mineral blend additive provided according to the present invention is the preferred enhancement of the color properties of the dried distiller grains for a more pleasant looking product. In yet another embodiment of the present invention is the provision of a blend wherein when added to distiller grains as appropriate, enhanced the flowability to the dried distiller grains for a more efficient loading and unloading onto trucks and rail cars. In another embodiment of the present invention, the mineral additive blend is suitable to provide a lowering of the moisture level in the dried distiller grain, enhancing the value to the product.

A benefit of the additive according to an embodiment of the present invention is a source of at least an anti-oxidant wherein when ingested, provides a high negative ionic charge, attracting toxins and parasites for eventual removal through the digestive tracts of the fed animal. Another benefit of the mineral additive according to an embodiment of the present invention is the energy savings that may be attributed to the efficiency in drying, drying at a cooler temperature using less energy, or the optimized drying conditions given the use of an anti-caking additive in the DDGs.

The instant invention provides a process for the introduction and blending of an additive or mineral blend into dried distiller grains after drying and cooling of the distiller grains. In a typical DDGs manufacturing process, distiller grains are preferably produced wet, dried and cooled to enhance the capacity of the production system to load it into rail cars, trucks or move it to a storage facility. The level of drying may depend on several factors, including but not limited to: size of the grain fiber, length of time in storage, types of manufacturing process, distance from the dryer to the storage or transport facility, milling process, and more. In some instances, the level of agglomeration and efforts to prevent caking or clumping of the distiller grains are factored into the drying and cooling processes. In an embodiment of the present invention, a mineral blend additive is preferably added to the DDGs after the needed drying and cooling.

In the instant disclosure, agglomeration implies the likelihood or lack thereof of the wet- or dry-milled distiller grains to clump or cake up; a more clumped or caked up DDGs being less desirable as that adds to reduction in flowability. Depending on the desired flowability or the need to prevent or limit agglomeration of the DDGs, the process by which DDGs is dried or the distance from the milling, drying and cooling to storage may be modified. Said drying or cooling steps may by necessity, be optimized given the additive that essentially impacts the level of caking or clumping.

Without limitation to a combination or lack thereof, aside from the need for increased flowability or reduction in agglomeration, the mineral blend additive usable in the present invention preferably provide at least the following benefits or combinations of same. Said benefits may include functioning as a preservative for the DDGs; enhancing the color; lowering the moisture level; acting as an anti-oxidant; providing a high level of negative ionic charge; or combinations thereof. Another benefit of the additive of the present invention may be shown in the energy savings gained from operating the driers at a cooler temperature as the DDGs risk of agglomeration is reduced.

The preferred additive useful in the present invention may include calcium carbonate, a suitable combination of calcium carbonate (CaCO₃) and kaolin clay (Al₂Si₂O₅(OH)₄) and/or bentonite clay (Al₂O₃4SiO₂H₂O.) In some instances, the additive may be purely or substantially wholly made of about 100 percent calcium carbonate. For combination of additives, said additive is preferably between about 40 and 90 percent calcium carbonate and between about 10 and 60 percent Kaolin clay; more preferably between about 50 and 80 percent calcium carbonate and between about 20 and 50 percent kaolin clay; most preferably between about 60 and 70 percent calcium carbonate and between about 30 and 40 percent kaolin clay. The calcium carbonate usable in the present invention is preferable a food grade product in mineral form obtainable from NC Minerals, LLC of Sleepy Eye, Minn. The kaolin clay usable in the present invention is obtainable as a mineral suitable for combination with calcium carbonate from NC Minerals, LLC of Sleepy Eye, Minn. In some instances, kaolin may be used with or substituted with bentonite clay in similar amounts and usable in mineral form. Other forms of this calcined clay may be usable as appropriate for the intended purpose.

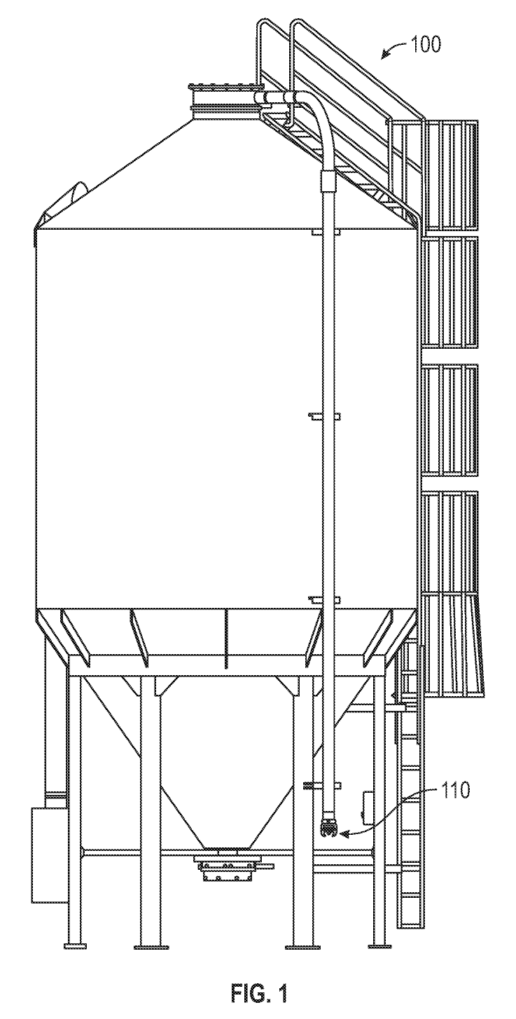

The additive or mineral blend of the present invention is preferably provided for use and delivered at point of blending via a pneumatic truck wherein said content are stored in bins for dispensing into tanks or bins. In this disclosure, bins, silos or storage barns may be implied or used interchangeably. Referring now to FIG. 1 showing a storage bin for the mineral blend according to the present invention having a receiving end 110 for use in connection with the pneumatic truck to deliver the mineral blend to the bin 100. The bin 100 usable in the present invention is preferably located between the cooler and storage for the DDGs or between the cooler and loading truck or rail cars. As used in the present invention, the blending process with the DDGs depends on plant set-up, storage or delivery process.

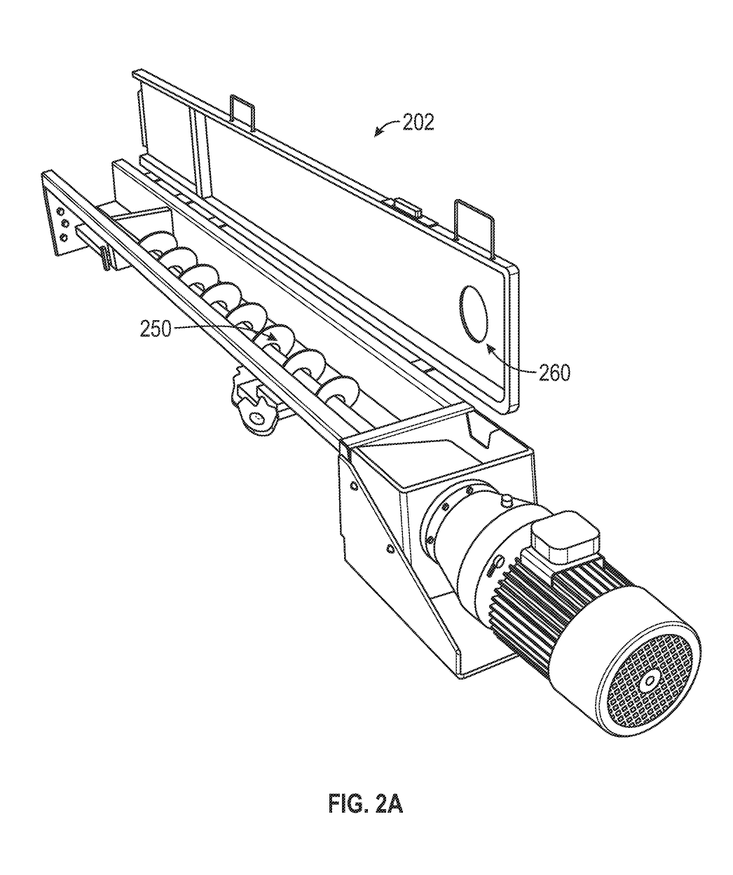

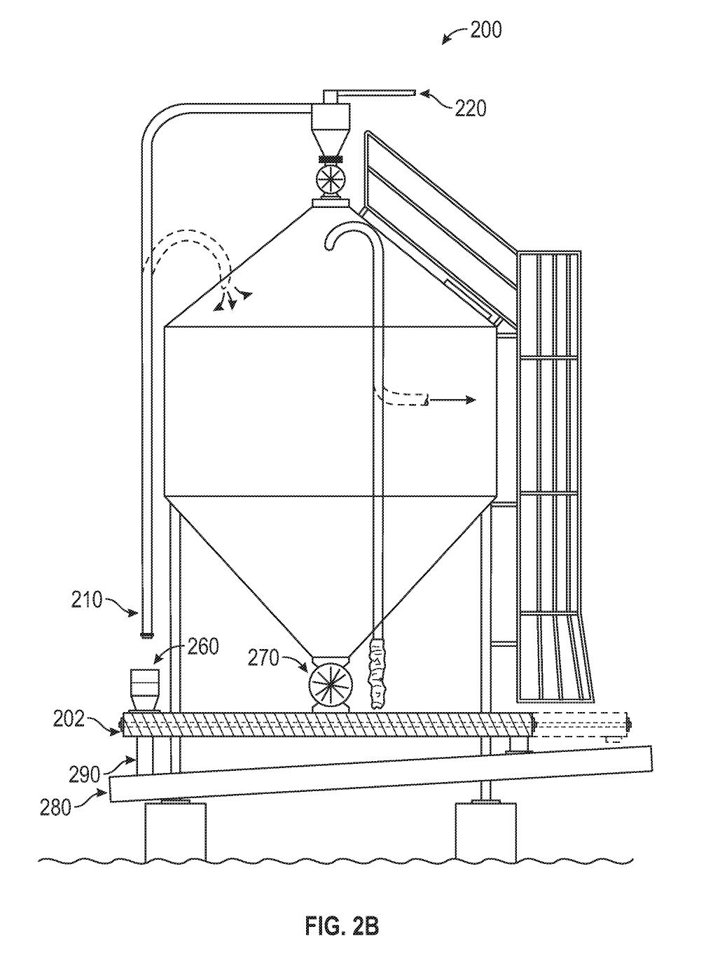

FIG. 2A depicts a typical screw conveyor 202 wherein DDGs and the mineral blend additive may be blended for use according to the present invention. The DDGs is typical fed in at 260 and a rotary valve entry point 270 is preferably available for the mineral blend additive as the screw turns to blend the components as desired.

FIG. 2B illustrates a bin 200 wherein receiving end 210 for the mineral blend is located at the side of the bin 200 and suitable for use in uploading the mineral blend. In a preferred embodiment of the present invention, the uploading of the mineral blend via the receiving end 210 displaces at several filter locations, outlets for air displacement to facilitate the mineral blend loading into the bin 200. When the bin 200 is full or in need of a bypass, the mineral blend may be diverted to the bag house 220. As shown in the relevant FIG. 2, the mineral blend may be stored in the bin 200 for use in blending with the DDGs.

In an embodiment of the process of the present invention, DDGs is fed in at receptacle 260 into a screw conveyor 250. The fed DDGs is preferably blended with the additive that is metered in via a rotary valve 270 into the screw conveyor at selected blend rates of between about 1 and 5 percent, more preferably, between about 2 and 4 percent and most preferably between about 2 and 3 percent of additive to DDGs ratio. The screw blending of the DDGs with the mineral blend additive may be accomplished in other methods as deemed appropriate and practical to incorporate the desired amount of mineral blend into the DDGs as intended. As shown still in FIG. 2, the blended (now non-agglomerated DDGs) may be loaded onto a conveyor process via 280 for storage or onto rail cars. As shown in FIG. 2, a bypass or slide gate 290 is provided according to the present invention for the DDGS as fed into the system when a blend may not be desired or if other system concerns occur to make typical blending according to the present invention impractical.

The process according to the present invention provides a mineral blended DDGs that may be loaded onto rail cars, trucks or stored for later use. It is a benefit of the present invention that the DDGs may be storable in vertical storage locations such as bins, silos or storage barns, reducing the space for flat storage given the reduced likelihood for clumping up or agglomeration.

Another benefit of the present invention is a reduction in typical drying that would be needed to remove the moisture in the wet-milled DDGs. Without the mineral blend additive, DDGs need to be totally dried in order to avoid clumping and then cooled prior to storage or loading onto to rail cars. According to the present invention, such drying may be modified or reduced as the blend dictates.

A mineral blended DDGs preferably provides an enhanced color as a finished product. Feed DDGs having enhanced colors are preferred in the marketplace as animal feeds. Said color enhancement typically provides value that may translate to increased demand and other related economic benefits. Typical L values of at least 50 is preferred; more preferably at least 55, and most preferably at least 58. An increased mineral content DDGs provides added health benefits for animal health as the high negative ionic charge has been shown to attract more toxins and parasites for removal via the animal digestive tracts.

### Example

In a quality control laboratory, about 20 grams each of dried distiller grains were collected from the conveyor after the cooling; in one instance before the introduction of the mineral blend additive; after the initial blending of a 2 percent mineral blend additive and after the initial blending of a 4 percent mineral blend additive. The addition of the mineral blend additive at each level is a composite indicating that the mineral blended dried distiller grain is either 2 or 4 percent additive respectively.

TABLE 1
Laboratory Results of DDGS Moisture Content

| DDGs Type | Moisture Content | % Difference |
|---|---|---|
| Untreated | 10.72 | n/a |
| 2% Treated | 9.54 | 11.0 |
| 4% Treated | 8.49 | 20.8 |

As shown in Table 1 above, the moisture content of DDGs provides the benefits of different levels of mineral blended DDGs. Incorporation of up to 4 percent mineral blend in the DDGs provides up to 20.8 percent reduction in moisture and likely reduction in agglomeration of the DDGs in storage. In some instances, the dried distiller grains (DDGs) may be termed dried distiller grains and solubles (DDGS)—such terms may be used interchangeably.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed is:

1. A method of producing mineral blend dried distiller grains, comprising:
providing dried distiller grains
providing a mineral blend additive, wherein said mineral blend comprises a blend of calcium carbonate, kaolin, bentonite or combinations thereof,
blending the mineral blend additive with the dried distiller grain, wherein the mineral blended dried distiller grain provides enhances flowability.

2. The method of claim 1, wherein the blending occurs after cooling of the dried distiller grain and prior to storage.

3. The method of claim 1, wherein the mineral blend additive comprises between about 40 and 90 percent calcium carbonate and between about 10 and 60 percent kaolin.

4. The method of claim 1, wherein the mineral blend additive comprises between about 50 and 80 percent calcium carbonate and between about 20 and 50 percent kaolin.

5. The method of claim 1, wherein the mineral blend additive comprises between about 60 and 70 percent calcium carbonate and between about 30 and 40 percent kaolin.

6. The method of claim 1, wherein the mineral blend is 100 percent calcium carbonate.

7. The method of claim 1, wherein the mineral blend is a combination of calcium carbonate and bentonite.

8. The method of claim 1, wherein the mineral blend additive lowers the moisture level in the mineral blended dried distiller grains.

9. The method of claim 1, wherein the mineral blend additive inhibits the growth or formation of mold spores in the mineral blended dried distiller grains.

10. The method of claim 1, wherein the mineral blended dried distiller grains is presented with preferred enhancement of color properties.

11. The method of claim 1, wherein the blending process utilizes a screw conveyor operably adapted to deliver between about 2 and 4 percent of the mineral blend additive to the feed of dried distiller grains.

12. The method of claim 1, wherein the mineral blended dried distiller grains is suitable for vertical storage.

13. An enhanced dried distiller grain, comprising a blend of:
dried distiller grains
a mineral blend additive, wherein said mineral blend comprises a blend of calcium carbonate, kaolin, bentonite or combination thereof, wherein
the mineral blended dried distiller grain provides enhances flowability.

14. The enhanced dried distiller grains of claim 13, wherein the blending occurs after cooling of the dried distiller grain and prior to storage.

15. The enhanced dried distiller grains of claim 13, wherein the mineral blend additive comprises between about 40 and 90 percent calcium carbonate and between about 10 and 60 percent kaolin.

16. The enhanced dried distiller grains of claim 13, wherein the mineral blend additive comprises between about 50 and 80 percent calcium carbonate and between about 20 and 50 percent kaolin.

17. The enhanced dried distiller grains of claim 13, wherein the mineral blend additive comprises between about 60 and 70 percent calcium carbonate and between about 30 and 40 percent kaolin.

18. The enhanced dried distiller grains of claim 13, wherein the mineral blend additive prevents the establishment of mold spores in the mineral blended dried distiller grains.

19. The enhanced dried distiller grains of claim 13, wherein the mineral blended dried distiller grains is presented with preferred enhancement of color properties.

20. The enhanced dried distiller grains of claim 13, wherein the blending process utilizes a screw conveyor operably adapted to deliver between about 2 and 4 percent of the mineral blend additive to the feed of dried distiller grains.
